(19) United States
(12) Patent Application Publication
(10) Pub. No.: US 2014/0335491 A1
(43) Pub. Date: Nov. 13, 2014

(54) OBSERVABLE DATA COLLECTION AND ANALYSIS

(71) Applicant: George Mason Intellectual Properties, Inc., Fairfax, VA (US)

(72) Inventors: Michael M. BEHRMANN, Fairfax, VA (US); Shuangbao WANG, Fairfax, VA (US); Heidi J. GRAFF, Vienna, VA (US)

(73) Assignee: George Mason Intellectual Properties, Inc, Fairfax, VA (US)

(21) Appl. No.: 14/242,360

(22) Filed: Apr. 1, 2014

Related U.S. Application Data
(63) Continuation of application No. 11/562,239, filed on Nov. 21, 2006, now abandoned.

(51) Int. Cl. G09B 19/00

(52) U.S. Cl. CPC G09B 19/00
USPC 434/238

(57) ABSTRACT

An observable behavior data collection and analysis system including at least two database collection modules and an analysis module. The database collection module(s) include a parameter storage module, an observable behavior data prompt module, an observable behavior data collection module, a collection phase assignment module, and a server storage module. An instructor observes a subject performing a prompted task and enters the observed data into one of the database collection modules. The data is stored on a server. The analysis module, which includes a filter module and an output generation module, reads the data from the server and generates interactive graphs that may be used by the instructor to treat the subject.

### CROSS-REFERENCES TO RELATED APPLICATIONS

This application is a Continuation application of U.S. patent application Ser. No. 11/562,239, filed Nov. 21, 2006, which claims the benefit of U.S. Provisional Application No. 60/738,026, filed Nov. 21, 2005, and entitled “Kellar Instructional Handheld Data System,” which is hereby incorporated in whole by reference.

### STATEMENT REGARDING FEDERALLY SPONSORED RESEARCH OR DEVELOPMENT

This invention was made with government support under Stepping Stones of Technology grant 83.327A awarded by the Department of Education. The government has certain rights in the invention.

### BACKGROUND OF THE EMBODIMENTS OF THE INVENTION

The No Child Left Behind Act's mandate for accountability and maximum access to the general education curriculum embodied in the Individuals with Disabilities Education Improvement Act is leading to higher expectations and greater accountability for schools and students with disabilities. Consequently, there has been an increased focus on data driven decision making. Simultaneously, there has been an increase in the number of students receiving special education services. Therefore, there exists a pressing need for an uncomplicated system of one-touch data collection.

Autism: Autism is one of several Pervasive Developmental Disorders (PDDs) that are caused by a dysfunction of the central nervous system leading to disordered development. All children with PDD are characterized by qualitative impairments in social interaction, imaginative activity, and both verbal and nonverbal communication skills. Historically, 50-75% of individuals with Autism also have some degree of mental retardation.

The reported prevalence of Autism has increased dramatically over the past 20 to 30 years. In the 1970s the reported prevalence was considered to be approximately 1 in 2,500 births. Recent studies found that the prevalence of Autism may range between 1 in 250. According to the Autism Society of America, Autism is the fastest-growing developmental disability with 10-17% annual growth. In the state of Virginia the number of schoolchildren with Autism has increased from 571 in 1991 to 3533 in 2003. In some states, the number of identified Autism cases has increased at an astounding rate. The state of Maryland reported the increase of the number of schoolchildren with Autism from 28 in 1991 to 3536 in 2003. An increase in the prevalence of Autism necessitated research into effective instructional strategies, which resulted in the implementation of discrete trial training for students with Autism.

Discrete Trial Training: Discrete trial training (DTT) is a method for individualizing and simplifying instruction to enhance children's learning. For children with Autism, DTT helps them acquire a variety of skills in important areas such as communication, social interaction, self-care, and academics. DTT can also be used to teach more advanced skills and manage disruptive behavior. In addition, some investigators have reported that when it is applied as part of a comprehensive applied behavior analysis (ABA) treatment program, DTT yields major long-term benefits for many children with Autism, including increases in IQ and decreases in the need for professional services, such as more restrictive special education placements. Moreover professionals and family members can implement DTT.

DTT is based on the applied behavior analysis (ABA) procedure. Over the past 30 years the application of the principles of ABA and discrete trial procedures to meet the needs of children with Autism has been subjected to hundreds of meticulous studies on the effectiveness of DDT/ABA in educating students with Autism. Each of these investigations demonstrated the power of ABA and DTT to alter the developmental trajectory of children with Autism and to have a significant impact on learning outcomes.

ABA relies on accurate interpretation of the interaction between behavioral antecedents and consequences, and use of this information to systematically plan desired learning and behavior change programs. The behavior analyst uses data review to develop hypotheses as to why a particular behavior occurs in a particular context without regard to etiology or “cause,” and then develops interventions to alter identified behavior(s). Information obtained from behavior analysis, therefore, may be used to purposefully and systematically modify behavior. Due to the nature of structured teaching and precision teaching principles, comprehensive data collection on student performance has become a strong component of educational programming for children with Autism and other PDDs. The Committee of Interventions for Children with Autism recommended that, “ongoing measurement of educational objectives must be documented in order to determine whether a child is benefiting from a particular program” and then objectives should be adjusted in response to the data.

Assessment Driven Instruction: The educational system fails to meet the needs of children with Autism due to the insufficient number of schools offering ABA services because of the difficulty of data collection and analysis. Carefully planned, individualized, systematic instruction based on the principles of ABA can be essential. It is important to have data-based decision making regarding teaching programs to permit responsive modifications of instructional strategies based upon the data.

ABA is grounded in data-based decision making. Assessment driven instruction promotes accountability at federal, state, and local levels. In addition to legal requirements, assessment strengthens educational decision making by (a) promoting objective decisions, (b) revealing incremental improvements and/or stagnated progress, and (c) predicting future progress. Effective use of assessment data may involve summaries, graphs, and rule-based decisions. Graphic representations assist with this process and their visual format promotes communication between parents, teachers, and other school personnel. Data collection systems should be simple, efficient, user-friendly, and socially appropriate. Research has shown that on-going monitoring of student progress generates more appropriate decisions regarding instruction, and consequently, greater outcomes for students. Acquisition of learned skills can lead to better outcomes for students with increased employment and enhanced quality of life for individuals with disabilities.

Despite the demonstrated importance of data collection and analysis, they are not always used appropriately to guide instruction. It has been found that teachers were more likely to analyze raw data. Another study found teachers tended to place less emphasis on the data they graphed when making instructional decisions, focusing more on training data than probe data. Teachers report that it is difficult to manage data collection. With the emphasis on inclusion and increased student caseloads, time constraints have become more pronounced. Teachers struggle to find a balance between teaching and data collection. Consequently, special education teachers are relying more on paraprofessionals who have little or no training in data collection. Furthermore, special education positions are often staffed with personnel holding alternative and emergency certificates, who may lack training in data collection and analysis. The barriers to data collection and analysis are concentrated around issues of management, time, and skill.

Currently Available Devices: Federal initiatives to develop technology-based single subject data collection systems are longstanding as reflected by R. Zuckerman's data procedure project and M. Snell's work on effective use of performance data by teachers in the 1980's. Similarly Hasselbring's AimStar, an Apple IIe software program, commercially available in the early 1980s, was designed to utilize student performance data in a Precision Teaching model. Zuckerman's program has been adapted for notebook computers and is still available, while the work of Hasselbring and Snell, as well as, Jon Tapp's Multiple Option Observation System for Experimental Studies, MOOSES, has fallen victim to the rapid progress of technology.

Presently, technology-based commercial data collection systems are available, such as the Discrete Trial Trainer by Accelerations Educational Software, Learner Profile by Sunburst, the Behavioural Evaluation Strategy and Taxonomy (BEST) from Scolari, The Observer by Noldus Systems, and HanDBase by DDH Software. However, they are either so limited that they require the developer to add new skills to the curriculum content, so complex that they are better suited to behavioral research, or so cumbersome that they require an entire curriculum be entered before beginning. As a result, teachers still do not utilize them to collect and analyze student performance data.

Data analysis programs have also emerged. However, these programs separate data collection and analysis, perpetuating the time consuming nature of data-based instructional decision making. A modified excel programs had been developed to create Behavior Feedback and Analysis Tool (BFAT), which displays data in graphic form. This program requires teachers to spend approximately fifty minutes a week inputting previously collected data. The big issue is finding the time to input the data. Additionally, graphing discrete trial data with Microsoft Excel requires extensive training as demonstrated by manuscripts dedicated to this topic.

Consequently, there is a need for technology based data collection alternatives to promote efficient and effective data collection and instructional decisions.

### BRIEF DESCRIPTION OF THE SEVERAL VIEWS OF THE DRAWINGS

FIG. 1 is a block diagram of an aspect of an embodiment of the present invention.

FIG. 2 is a flow diagram of an aspect of an embodiment of the present invention.

FIG. 3 shows an example Administrative Page screen shot as per an aspect of an embodiment of the present invention.

FIG. 4 shows an example Secondary Behavior Association Page screen shot as per an aspect of an embodiment of the present invention.

FIG. 5 shows an example Parameter Page screen shot as per an aspect of an embodiment of the present invention.

FIG. 6 shows an example Task Page screen shot as per an aspect of an embodiment of the present invention.

FIG. 7 shows an example Graph Page screen shot as per an aspect of an embodiment of the present invention.

FIG. 8 shows example PDA Data Collection Screen shots 1-3 as per an aspect of an embodiment of the present invention.

FIG. 9 shows example PDA Data Collection Screen shots 4-6 as per an aspect of an embodiment of the present invention.

FIG. 10 shows example data collection Screen shots 7-9 as per an aspect of an embodiment of the present invention.

FIG. 11 shows an example of an anecdotal report screen shot as per an aspect of an embodiment of the present invention.

FIG. 12 shows an example of Regan's Sample Data as per an aspect of an embodiment of the present invention.

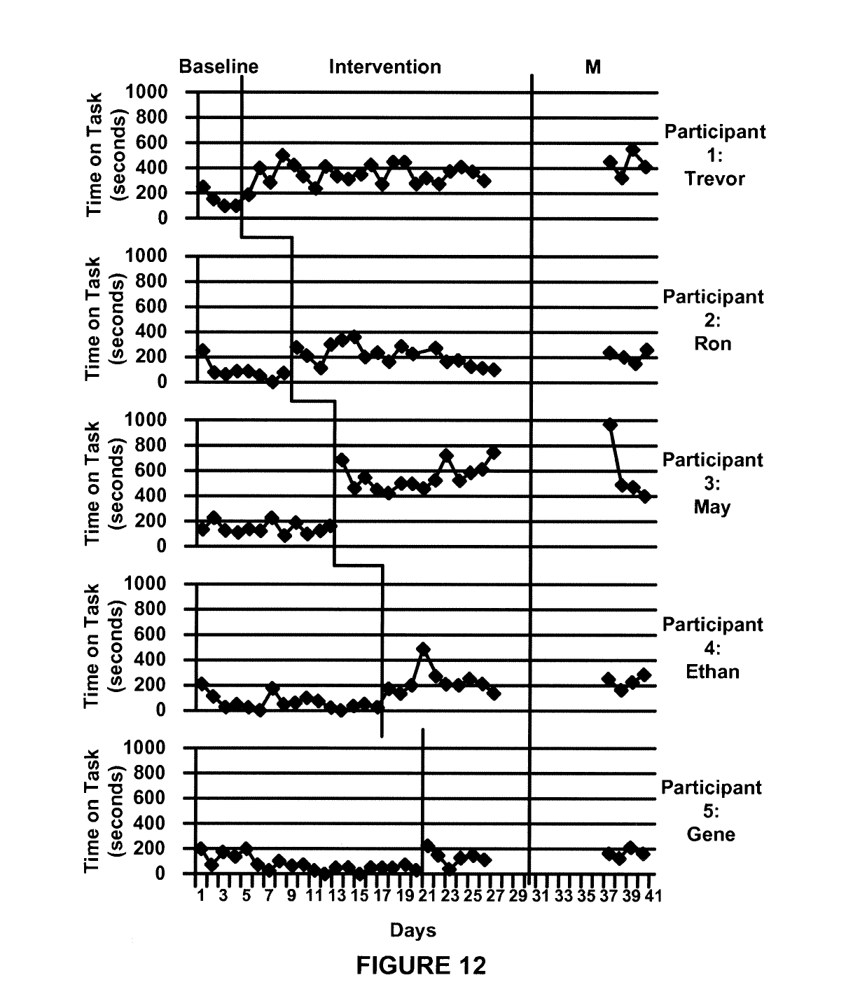

### DETAILED DESCRIPTION OF EMBODIMENTS

An embodiment of the present invention may be used by teachers and parents to collect and analyze data of children with special needs to facilitate data-driven, educational decisions to ultimately improve student outcomes.

There exists a pressing need for an uncomplicated system of one-touch data collection. Embodiments of the present invention were developed to meet this need. The inventors have called embodiments of the system the Kellar Instructional Handheld Data (KIHd). Embodiments of the KIHd Systems have been implemented using universally accessible Internet (browser based) Personal Digital Assistant (PDA) and Personal Computer (PC) data collection systems. This system is appropriate for use with children with disabilities enabling wireless discrete data collection using a database such as Microsoft Access, a commonly available database, for data analysis

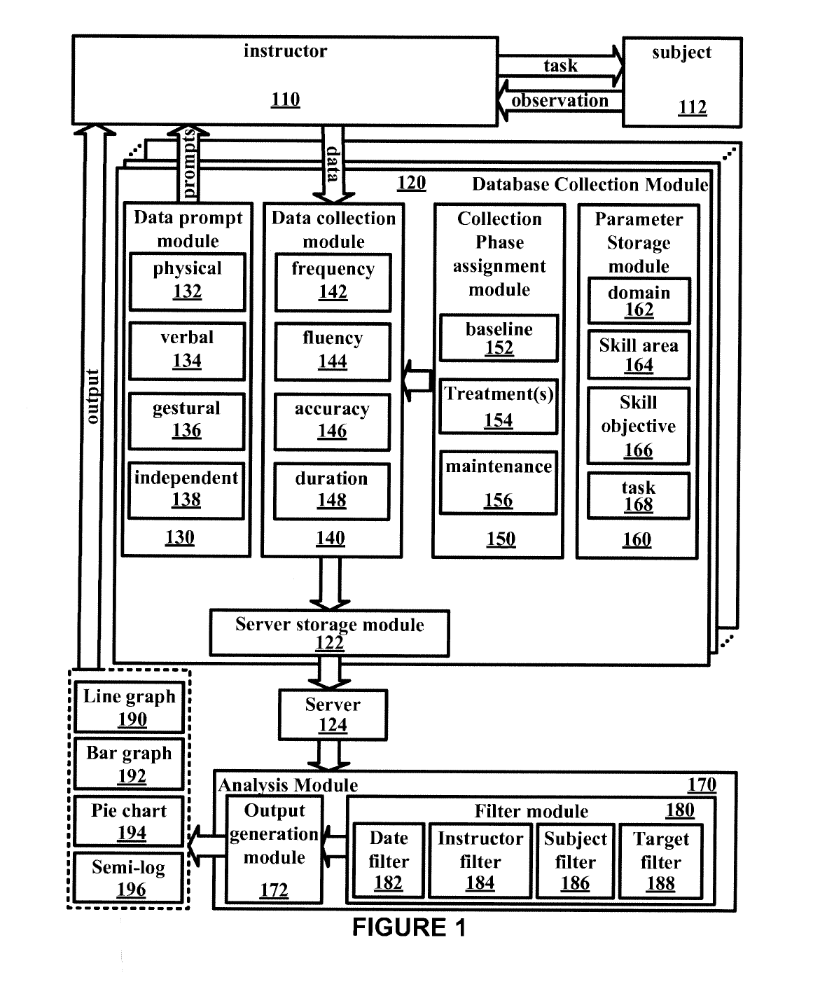

FIG. 1 is a block diagram of an embodiment of a system for collecting and analyzing observable behavior data. The system preferably includes at least two database collection modules 120 and an analysis module 170. Modules may be implemented using hardware, software, firmware either singularly or in combination.

The database collection module(s) 120 include a parameter storage module 160, an observable behavior data prompt module 130, an observable behavior data collection module 140, a collection phase assignment module 150, and a server storage module 122. Data collection modules 120 may be embodied in a mobile device such as a PDA or laptop.

The parameter storage module 160 is preferably configured to store parameters that operationally describe an observable behavior for a task. The parameters may include, but are not limited to, domain(s) 162, skill area(s) 164, skill objective(s) 166, and tasks (168). A domain can specify the sphere of the behavior such as social, emotional, or cognitive behaviors. Parameters may include additional data such as a task distractor parameter which limits the number of other similar items in a subjects 112 perceptual field, a task instruction that suggests a stimulus discriminate for an instructor 110 to use when interacting with a target 112, a target response that suggests how a subject 112 should respond back to an instructor 110, a task material, or a task mastery criteria that will help an instructor know when a trial is done.

The observable behavior data prompt module 130 is preferably configured to prompt an instructor 110 for observable behavior data from a physical entity 112 such as a student. An instructor 110 can be any person making an observation such as a teacher, a parent, a paraprofessional, or a veterinarian etc. The physical entity 112 need not be limited to students. The physical entity 112 could be any entity which exhibits behavior including animals or robots. The prompt(s) for observable behavior data may include a prompt for physical behavior data 132, a prompt for verbal behavior data 134, a prompt for gestural behavior data, 136, or a prompt for independent behavior data 138. Additionally, the prompt(s) for observable behavior data may be expanded to include requests for additional types of data. For example, the prompt(s) may include a prompt for: modeling data; a prompt for modeling correct data; a prompt for modeling incorrect data; a prompt for at least one user generated data type; a prompt for modeling faded physical data; a prompt for modeling faded verbal data; and a prompt for modeling full physical data.

The observable behavior data collection module 140 is preferably configured to collect observable behavior data. Observable behavior data should include all of the following primary behavior data including: frequency learning 142; fluency learning 144; accuracy learning 146; and duration learning 148.

The collection phase assignment module 150 is preferably configured to assign the collected observable behavior data to a collection phase. Collection phase(s) can include a baseline phase 152, a treatment phase 154; and one or more maintenance phases.

A server storage module 122 may be used to store the observable behavior data on a server 124. The server 124 may be available through a wired or wireless connection. Observable behavior data may be stored on a server 124 in real-time (possibly through a wireless link) or stored on at database collection module 120 and synchronized with the server 124 at a later time. It is envisioned that in some embodiments, the server 124 may be built into the database collection module.

The analysis module 170 preferably includes a filter module 180 and an output generation module 172. The filter module 180 is preferably configured to apply at least one filter to the observable behavior data. Examples of filters include date filters 182, instructor filters 184, subject filters 186, and target filters 188. A target 112 is the object that data is being collected on. The output generation module 172 is preferably configured to generate an output which may include an interactive graph of the filtered observable behavior data. Examples of interactive graphs include line graph(s) 190, bar graph(s) 192; pie chart(s) 194, and semi-logarithmic graph(s) 196. It is envisioned that the output will be used by the instructor to help guide the subjects 112 treatment. The output may also include a report, either in electronic or paper form. In some embodiments, the data collection module 140 and the analysis module 170 can be the same.

Observable behavior data may include learning ability data and performance data. Additionally, the observable behavior data may include secondary behavior characteristics. Secondary behaviors include behaviors that may prevent learning. Secondary behavior characteristics may be collected with primary behavior data. Anecdotal data may be collected with the collection of observable behavior data. Anecdotal data can include explanations to explain the current data. For example, anecdotal data may include comments like “the subject is tired,” or “the subject is sick.”

Enabling customization of the system may make the system more user friendly. Example of customization may allowing filter(s), secondary observable behavior data, collection phase(s), or the like, to be given user specified names.

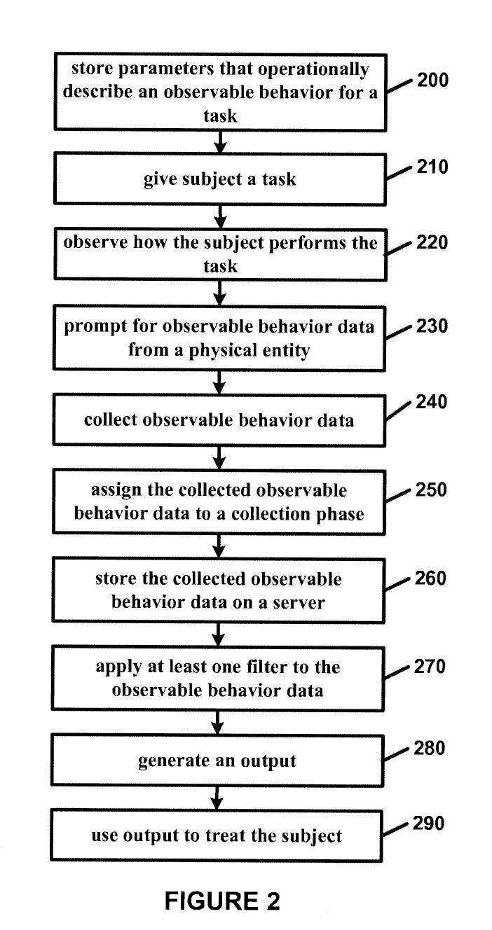

FIG. 2 shows a flow diagram for collecting and analyzing observable behavior data as per an aspect of an embodiment of the present invention. Like the blocks shown in FIG. 1, the actions illustrated in FIG. 2 may be implemented using hardware, software, firmware either singularly or in combination.

At 200, parameters may be stored that operationally describe an observable behavior for a task. This storage may need to be done in advance of the other actions described in the figure. The parameters may include: a domain; a skill area; and a skill objective. Additionally, the parameters may also include other data such as task distractor(s), a task instruction(s); target(s), task material(s), and task mastery criteria.

The subject may then be asked to perform the task at 210, so that an instructor may observe the subject performing the task at 220. An instructor may then collect the Observable behavior data related to the task at 240 in response to prompts at 230. Observable behavior data may include learning ability data and performance data. The observable behavior data may include all or part of the following primary behavior data (depending on the specific embodiment): frequency learning; fluency learning; accuracy learning; and duration learning. Additionally, the observable behavior data may also include secondary behavior characteristics that prevent learning as well as anecdotal data.

The prompt(s) may include a prompt(s) for physical behavior data; prompt(s) for verbal behavior data; prompt(s) for gestural behavior data; and prompt(s) for independent behavior data. The prompt(s) for observable behavior data from a physical entity may further include additional other prompts such as prompt(s) for modeling data, prompt(s) for modeling correct data, prompt(s) for modeling incorrect data, prompt(s) for user generated data type(s), prompt(s) for modeling faded physical data, prompt(s) for modeling faded verbal data, and prompt(s) for modeling full physical data.

At 250, the collected observable behavior data may be assigned to collection phase(s). Collection phase(s) may include at least one of the following: a baseline phase; treatment phase(s); and a maintenance phase. The collected observable behavior data may then be stored the on a server at 260.

At least one filter may be applied to the observable behavior data at 270. Filters may include date filters, instructor filters, subject filters, and target filters. Output(s) may be generated using filtered or non-filtered observable behavior data at 280. The output(s) may include interactive graph(s) such as line graph(s), bar graph(s), pie chart(s), and semi-logarithmic graph(s). Outputs may also include reports. Finally, the outputs may used by instructor(s) at 290 to guide future treatment for the subject.

Embodiments of the KIHd System provide new technology to support the innovative practice of one-touch data collection whereby the data is collected and inputted at the same time. Maximizing data with effective analysis is critical (McIntire, 2005). The KIHd System is potentially useful for students with a variety of disabilities. An example of such a population includes students with Autism where teachers are more frequently trained in and currently practicing DTT. This ensures that the research is testing the efficacy of the tool and not training teachers to collect data. Computer and web-based technology are leading to broader access to efficient tools for teachers to use in determining student progress in learning activities due to new developments in wireless, handheld, and database interface technology.

This technology based data collection tool is unique in its class and is an easy-to-use teacher-friendly tool. Extensive usability testing has been conducted at George Mason University (GMU), Users need not enter an entire curriculum along with data collection parameters at the start. Instead, embodiments of the KIHd System allows educators and other data collectors to begin collecting chosen individual student performance data. Later, they can organize the curricular content, including linking it to the general education curriculum. The KIHd System is designed for collecting discrete performance data on subjects such as children with disabilities for whom discrete data performance collection is appropriate.

As a tool, the KIHd System is designed so that data collectors, teachers, parents, aides, and volunteers can collect individual performance data on a handheld device. That information (data) may be stored making analysis possible using commonly available database software tool such as Microsoft (MS) Access. Collectively, the system can provide for access online with data collected and stored using wireless Internet technology. Information may be collected via a PDA using Internet Explorer (or another browser) interfaced with server software where MS Access stores and analyzes the data. Data collectors “touch” the data only one time. The numeric and graphic representation of the student performance is immediately available to them, either through a web browser access to the server or through a browser PDA graphic interface displaying the last 10 sessions. The browser based system may be designed to be 508 accessible, but many users with disabilities may need to use the computer based system in order to access the software (e.g. using Jaws or screen enlargement software that is unavailable on PDAs).

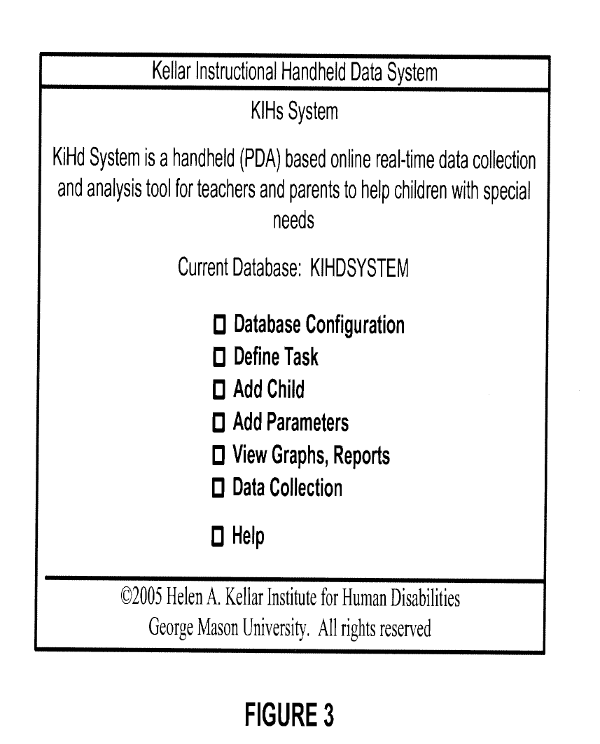

The administrative tool page shown in FIG. 3 is an example of a simple interface to the MS Access database on the server (online). From this page parents, teachers, and/or paraprofessionals can select their database configuration, define task, add or edit child information, add a parameter, view the graphs and reports or begin to collect data. While teacher, parents and/or paraprofessionals can use the system, for the discussion purposes the generic user will be referred to here as a teacher. Although most data will be collected using the PDA, data collection can take place using the PC.

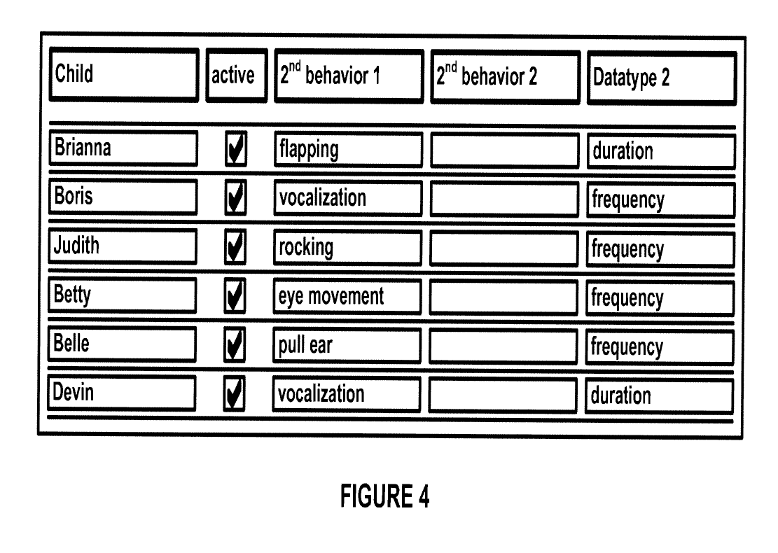

If the teacher wanted to add a new child, she would go to the child page. At this site children can have secondary behaviors associated with their name. For the example shown in FIG. 4, Brianna has a flapping behavior. This association allows the teacher to collect secondary data on how long Brianna flaps during a period of time, perhaps circle time or work time. By collecting information on secondary behaviors, the behavior can be analyzed, and new socially appropriate behaviors may be introduced.

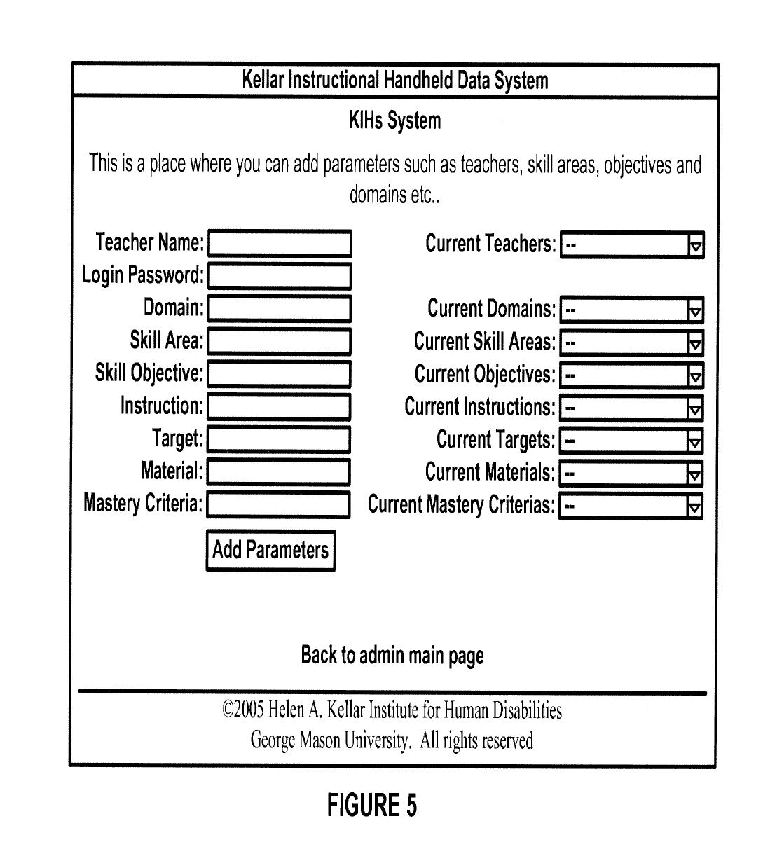

If the teacher chooses to add a new item to the curriculum, the parameter page shown in FIG. 5 can be selected. This page adds or edits a teacher and adds information into the KIHd System.

The login password shown can protect information entered into the system. The parameters for defining each item can consist of the following information: domain name (physical, cognitive, etc.), skill areas (area of instruction), skill objective (naming the item to be taught), instructions (stimulus to be used), targets (what the child's response will be), material (items needed to implement the lesson), and mastery criteria (the percentage of correct needed for proficiency). For instance, a teacher may want to teach a lesson on colors. The domain in this case is cognitive with the skill area being pre-academic colors. The skill object is to learn blue and the teacher instructions may be a verbal directive of “touch blue” with the target being the child touching the blue card. The materials would be the cards of and the mastery criteria of 90%.

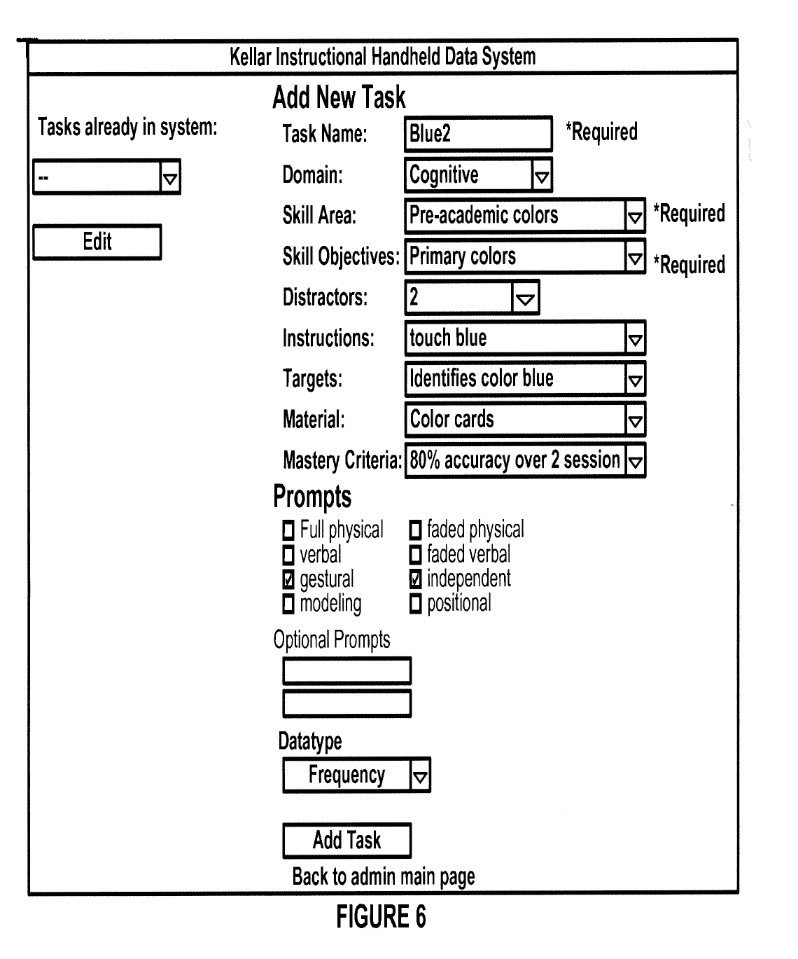

Once those parameters have been added, the teacher may need to define the specific task by going to the example task page shown in FIG. 6.

The tasks page provides access to a simple interface to assist in the creation or editing of each learning component or “task.” Here the information previously entered may be narrowed down by providing a task name and associations, such as distractors (2 with red and yellow), prompt level (gestural or independent prompting-how will you help the child), and data type (frequency—the type of data you will collect for this task). The KIHd System can collect four types of data: frequency (number of correct responses), duration (time to complete), accuracy (number correct over the total number), and fluency (number of correct responses over a time frame).

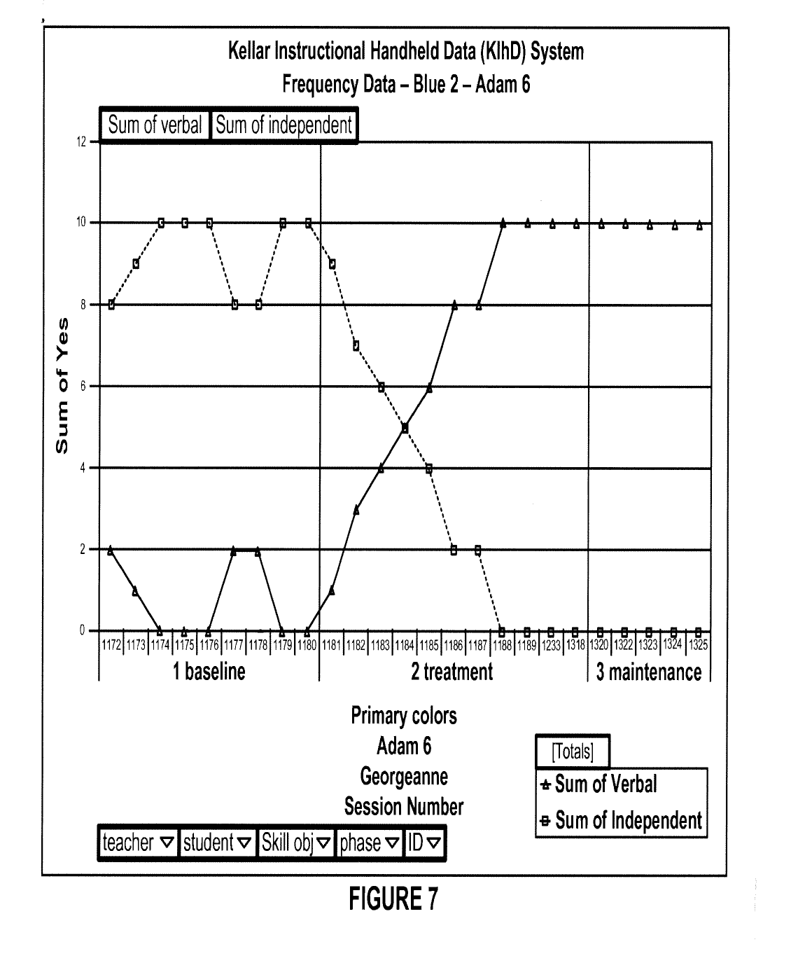

The example graph page shown in FIG. 7 provides access to the visual graphic displays of student performance, either individual students or groups of students, according to the standard display criteria of the Association of Behavior Analysis. All data will be able to be analyzed according to baseline, treatment or maintenance phases of instruction. The data will be able to be presented in traditional ABA type line graphs or understandable bar charts or pie graphs.

This analysis tool will enable instructors to look at individual performance by: a) skill objectives or across skill objectives in skill areas or domains; b) across instructors (according to individual performance skill objectives or across skill objectives in skill areas or domains); or c) groups of children across instructors, skill objectives, skill areas or instructional domains. The analysis tool may be designed to achieve two major goals. First, to provide data collectors with immediate feedback on the individual student performance based on the student's previous performance with various instructors in a specific skill.

The second goal of the analysis tool can be to provide the primary instructor with a visual analysis of student performance over time. It can rely on the data collected during instruction and is preferably available immediately. Analysis data could be used for: 1) looking at individual student performance (frequency, duration, fluency, etc.); 2) looking at instruction by a single data collector (teacher, parent, aide, volunteer) across students; 3) and looking at group data across an individual class of students. If desirable, data across multiple classes could be merged to look at program wide performance data. It is also possible to collect data on inter-rater reliability by having two observers collect data simultaneously. It is important to note that the session numbers are collected sequentially in the data base across all students and therefore are in order of the data collected but not sequential for each student. Additionally, alternative displays such as bar graphs and pie charts may be made available to enable other views of performance (e.g. percentage of students achieving stated goals across students) and the semi-logarithmic charts that are used in precision teaching to determine fluency (rate and accuracy).

The hope is that armed with this rich information on performance that the teacher will be immediately be able to make instructional data decisions child by child based on his or her previous performance. Additionally, data will be available for IEP decisions related to domains, skill areas, skill objectives, personnel, and time. Finally, LEAs will be able to analyze data across interventions, using random assignment and statistical measures to show efficacy of interventions.

Perhaps for the first time, the primary instructor will be able to see success and rates of students and the adults with whom they work on individual objectives (tasks) that would become a stimulus for increased understanding about performance and learning needs. With this deeper understanding of data use, instructors could use collected information as a more meaningful precursor to decision making about instruction.

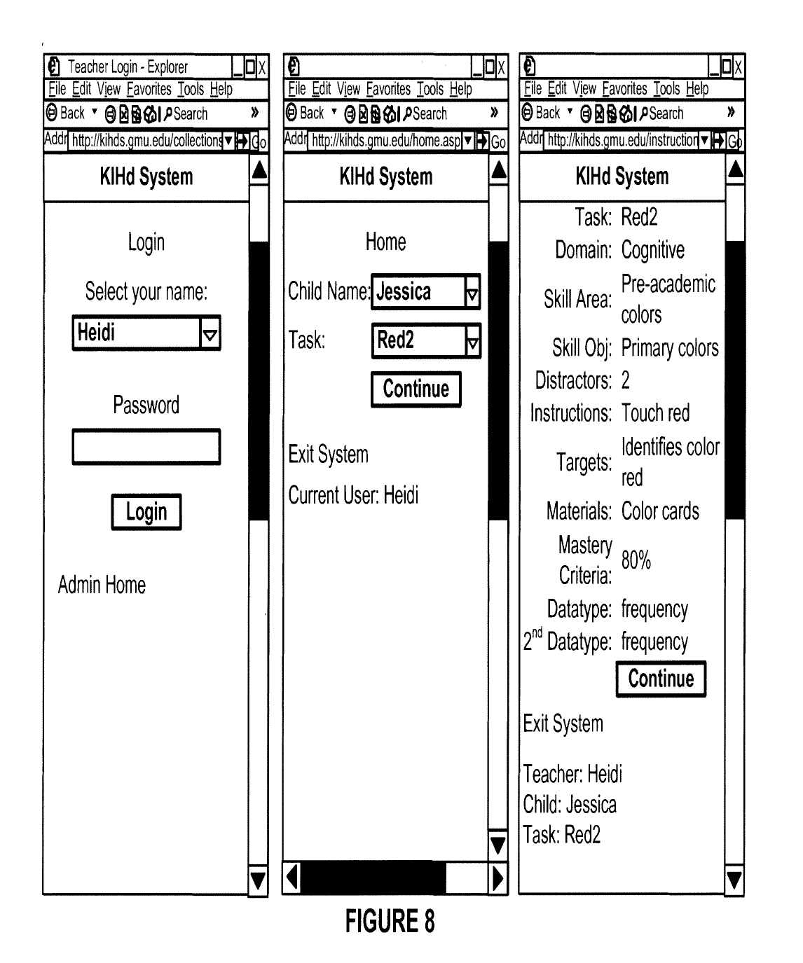

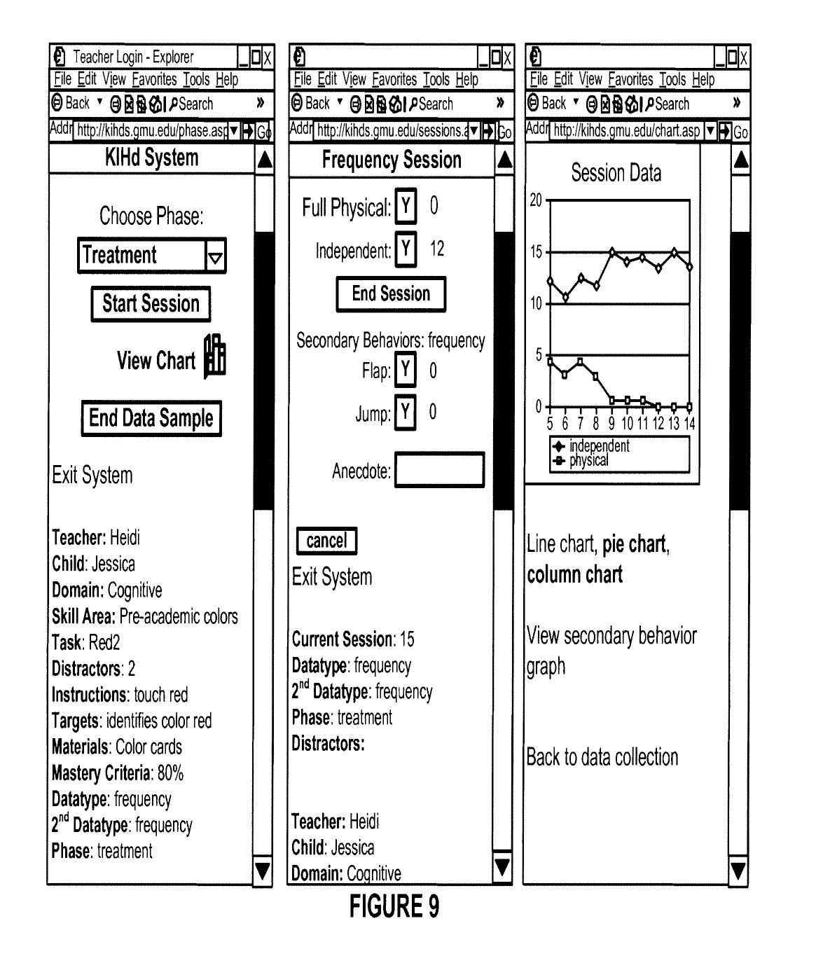

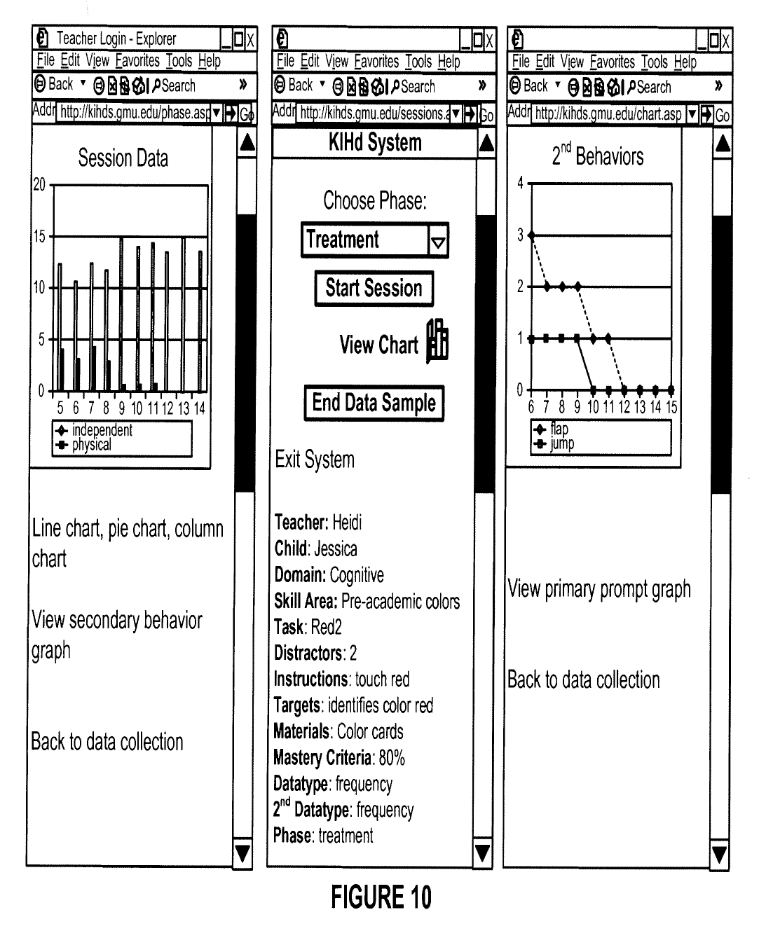

While the PC platform may primarily analyze the data, define and add information via the administrative tool pages, the PDA may be used to mainly collect the data. The PDA based data collection tool (example screen shot of which are shown in FIG. 8, FIG. 9 and FIG. 10) may be designed to work in the following way:

Example Screen 1: Teacher enters a “Login” screen to identify the person who will be collecting the data and enters a password. Selects “continue” to move to next screen.

Example Screen 2: Teacher identifies “student” and desired instruction task to be taught. Selects “continue” to move to next screen.

Example Screen 3: Teacher confirms domain, skill area, skill objective, distractors, instructions, targets, materials, mastery criteria, datatype, and secondary behavior datatype. Selects “continue” to move to next screen.

Example Screen 4: PDA confirms selections from screens 1-3 in “cookies” on the left side of screen 4. At this point the teacher can view the graph to review the performance data for previous instruction on that particular skill objective with that particular student or begin collecting data by selecting “Start Session.” The teacher may also selects Phase (Baseline, Treatment or Maintenance).

Example Screen 5: Teacher collects data on individual student performance. PDA confirms selections from screens 1-5 in scroll down menu. Actual data collected (E.g. frequency of correct and incorrect responses and prompt level used) for each trial during a session is seen on the PDA screen. Any number of trials makes up an individual session but 10 trials are recommended. During the data collection, secondary behaviors may be monitored and anecdotal information may be gathered. When the session is complete the teacher selects “End Session” and is automatically taken back to screen 5.

Example Screen 6: The session data is to be viewed for immediately analysis. Here a line chart can be viewed with the blue line for independent and the red for physical prompting over 10 sessions.

Example Screen 7: Session data can also be viewed in a bar format.

Example Screen 8: More session can be implemented or “End Data Sample” can be selected.

Example Screen 9: Secondary behavior data can also be view.

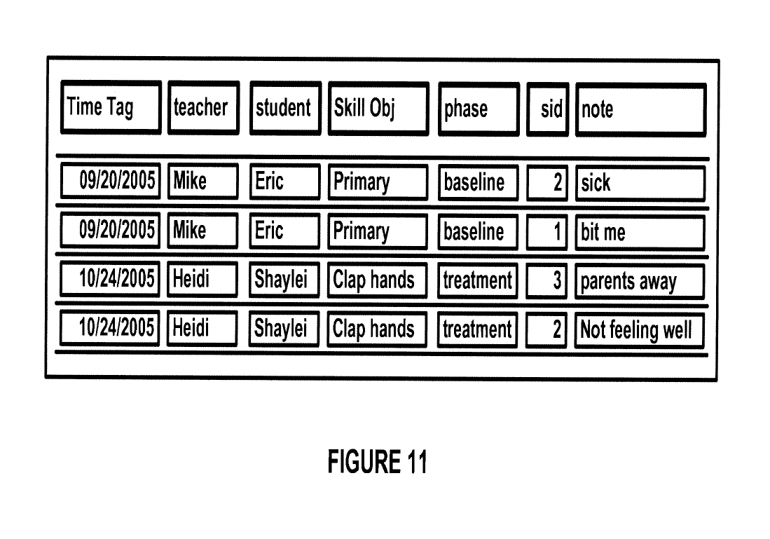

Anecdotal information may be stored during data collection on example screen 5 and then retrieved in a chart format (FIG. 11) from the PC.

The KIHd System may be used in conjunction with the Internet by both instructional specialist and parents. In contrast to other expensive self-contained programs that must be utilized by specialists through purchased curriculum or program enrollment, the materials from embodiments may potentially be downloaded off the Internet. The proposed materials may be made available to parents, tutors, and teachers without current access to other existing data collection programs.

A simple user interface such as those shown in the example figures may be supported using XML based programming code to link browsers to commonly available software, Microsoft Access.

An example of embodiments in use is as follows. Two groups of participants were included in a test use. The first group encompassed seventeen students in a program for young adults with intellectual disabilities such as significant learning disabilities, cognitive disabilities including mental retardation and developmental disabilities such as Autism (students' intellectual disabilities might also be accompanied by physical/sensory disabilities). The program provides instruction in functional literacy skills, technology, career exploration/employment, and independent living skills. The second group consisted of eight instructors.

The students have a variety of classes including the following: communication-technology, consumer or practical math skills, independent living, social dynamics, fitness, and graphic design. Certain lessons collected data types using the KIHd System. For example, Jerome was learning how to e-mail his friend in communication-technology class and the instructor wanted to monitored how long (duration) it took for Jerome to complete each e-mail and how many e-mails (frequency) Jerome completed during a class. The instructor and researcher entered the task parameters into the KIHd System. The instructor utilized the PDA's “one-touch” approach to input student responses by touching “yes” for frequency and starting the clock for duration. Upon task completion, analysis of the student's performance was reviewed on the PDA. Another task had Herbert learn how to estimate a grocery purchase in consumer math skills. Based upon the goals of the lesson, data was collected on how many problems Herbert answered correctly over the total number of problems (accuracy) or how quickly and correctly did Herbert calculate the answers (fluency).

Data were collected on each student participant across each data type. Baseline data were collected for one session before intervention. Interventions include a variety of teaching strategies ranging from direct teaching to modeling. The treatment phase ranged from one to ten sessions depending on the student's mastery level of the task and maintenance phase data were collected thereafter until the two week data collection period was completed. The researcher was available at all sessions to maintain consistency and fidelity of the data collection.

The need for accountability with special education students has vastly increased. Assessments for these students should produce reliable and valid information that leads to student learning and improved instruction. Documentation of student improvement on IEP goals through data collection and analysis might serve as one type of performance evidence. Therefore, efficient data collection and analysis tools are necessary to support school programs in documenting progress and making instructional decisions for students with disabilities. According to this need, the KIHd System, which provides input and output data, may be used by teachers to support their instructional strategies and to determine progress in learning activities. The ultimate mission of the KIHd project is to create a data collection system for teachers and parents of children with special-needs to facilitate data-driven, educational decisions that will ultimately improve student outcomes.

The KIHd System can have several levels of protection including: current database configuration, system pass code, teacher data collection identification and student identification code. For example, a database configuration may allow only defined people to access the data as defined by the programmer. For this study only project staff and teachers and parents may have access to the data. The system pass code permits only defined people to enter task parameters. The teacher data collection identification allows instructors to have a password to permit data collection. All instructors may be given a password. Each student may have an identification code as well. For purposes of confidentiality, all person-identifying data may be coded so that no one, including individual students, parents, instructors, families, can be identified.

Typically, teachers make instructional decisions based on visual inspection of graphs when the intervention data is the same or different than the data in the baseline phase. The KIHd System will enable teachers to use a more fine grained comparison using statistical probability from random assignment data rather than relying solely on visual differences in graphs. For example, the KIHd's statistical data may show improvement in student achievement that may not be easily discernable on a graph. Armed with better data the teacher can make a more informed decision on whether to maintain or change the intervention, resulting in improved student outcomes.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of embodiments used with Autistic subjects. However, one skilled in the art will recognize that embodiments of the invention could be used with subjects who have Mental Retardation, Learning Disabilities, Emotional Disabilities and Severe Disabilities at school and home settings.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

We claim:

1. An observable behavior data collection and analysis system, comprising:
(a) at least two database collection modules, each of the at least two database collection modules including:
(i) a parameter storage module configured to store parameters that operationally describe an observable behavior for a task, the parameters including:
(1) a domain;
(2) a skill area; and
(3) a skill objective;
(ii) an observable behavior data prompt module configured to prompt for observable behavior data from a physical entity, the prompt for observable behavior data including:
(1) a prompt for physical behavior data;
(2) a prompt for verbal behavior data;
(3) a prompt for gestural behavior data; and
(4) a prompt for independent behavior data;
(iii) an observable behavior data collection module configured to collect observable behavior data on a mobile device, the observable behavior data including all of the following primary behavior data, the primary behavior data including:
(1) frequency learning;
(2) fluency learning;
(3) accuracy learning; and
(4) duration learning;
(iv) a collection phase assignment module configured to assign the collected observable behavior data to a collection phase, the collection phase being at least one of the following:
(1) a baseline phase;
(2) a treatment phase; and
(3) a maintenance phase; and
(v) a server storage module configured to store the collected observable behavior data on a server;
(b) an analysis module, the analysis module including:
(i) a filter module configured to apply at least one filter to the observable behavior data, the filter including at least one of the following:
(1) date;
(2) instructor;
(3) subject; and
(4) target; and
(ii) an output generation module configured to generate an output, the output including an interactive graph of the filtered observable behavior data, the interactive graph including at least one of the following:
(1) a line graph;
(2) a bar graph;
(3) a pie chart; and
(4) a semi-logarithmic graph; and
wherein the output is configured to be used by an instructor to treat a subject.

2. A system according to claim 1, wherein the data collection module and the analysis module are the same.

3. A system according to claim 1, wherein at least one of the at least two data collection modules is a mobile data collection module.

4. A system according to claim 1, wherein the prompt for observable behavior data from a physical entity further includes at least one of the following:
(i) a prompt for modeling data;
(ii) a prompt for modeling correct data;
(iii) a prompt for modeling incorrect data;
(iv) a prompt for at least one user generated data type;
(v) a prompt for modeling faded physical data;
(vi) a prompt for modeling faded verbal data; and
(vii) a prompt for modeling full physical data.

5. A system according to claim 1, wherein the observable behavior data includes:
(a) learning ability data; and
(b) performance data.

6. A system according to claim 1, wherein the observable behavior data includes secondary behavior characteristics.

7. A system according to claim 6, wherein the secondary behavior characteristics are collected with primary behavior data.

8. A system according to claim 1, wherein the collection of observable behavior data includes collecting anecdotal data.

9. A system according to claim 1, wherein at least one of the at least one filter is given a user specified name.

10. A system according to claim 1, wherein the output includes a report.

11. A system according to claim 1, wherein the secondary observable behavior data can be given a user specified name.

12. A system according to claim 1, wherein the collection phase is given a user specified name.

13. A system according to claim 1, wherein the observable behavior data is stored on a server in real-time.

14. A system according to claim 1, wherein the observable behavior data is stored on at least one of the at least two database collection modules and synchronized with the server at a later time.

15. A system according to claim 1, wherein the parameters further include at least one of the following:
(a) a task distractor;
(b) an task instruction;
(c) a target;
(d) a task material; and
(e) a task mastery criteria.

16. A method for collecting and analyzing observable behavior data, comprising:
(a) storing parameters that operationally describe an observable behavior for a task, the parameters including:
(i) a domain;
(ii) a skill area; and
(iii) a skill objective;
(b) prompting for observable behavior data from a physical entity, the prompt for observable behavior data including:
(i) a prompt for physical behavior data;
(ii) a prompt for verbal behavior data;
(iii) a prompt for gestural behavior data; and
(iv) a prompt for independent behavior data;
(c) collecting observable behavior data on a mobile device, the observable behavior data including all of the following primary behavior data, the primary behavior data including:
(i) frequency learning;
(ii) fluency learning;
(iii) accuracy learning; and
(iv) duration learning;
(d) assigning the collected observable behavior data to a collection phase, the collection phase being at least one of the following:
(i) a baseline phase;
(ii) a treatment phase; and
(iii) a maintenance phase; and
(e) storing the collected observable behavior data on a server;
(f) applying at least one filter to the observable behavior data, the filter including at least one of the following:
(i) date;
(ii) instructor;
(iii) subject; and
(iv) target; and
(g) generating an output, the output including an interactive graph of the filtered observable behavior data, the interactive graph including at least one of the following:
(i) a line graph;
(ii) a bar graph;
(iii) a pie chart; and
(iv) a semi-logarithmic graph; and
wherein the output is configured to be used by an instructor to treat a subject.

17. A system according to claim 16, wherein the prompt for observable behavior data from a physical entity further includes at least one of the following:
(i) a prompt for modeling data;
(ii) a prompt for modeling correct data;
(iii) a prompt for modeling incorrect data;
(iv) a prompt for at least one user generated data type;
(v) a prompt for modeling faded physical data;
(vi) a prompt for modeling faded verbal data; and
(vii) a prompt for modeling full physical data.

18. A system according to claim 16, wherein the observable behavior data includes:
(a) learning ability; and
(b) performance.

19. A system according to claim 16, wherein the observable behavior data includes secondary behavior characteristics.

20. A system according to claim 16, wherein the collection of observable behavior data includes collecting anecdotal data.

21. A system according to claim 16, wherein the parameters further include at least one of the following:
(a) a task distractor;
(b) an task instruction;
(c) a target;
(d) a task material; and
(e) a task mastery criteria.
